(19) United States
(12) Patent Application Publication
(10) Pub. No.: US 2008/0279355 A1
(43) Pub. Date: Nov. 13, 2008

(54) Payment System and Method for Telephone Services

(76) Inventors: Josep Casals Castane, Barcelona (ES); Santiago Vernet Vidal, Barcelona (ES); Roger Martines Teres, Barcelona (ES)

Correspondence Address: EAGERTECH 21 S.L., VIA AUGUSTA 59, DESP. 223, BARCELONA, 08006, ES

(21) Appl. No.: 12/091,941

(22) PCT Filed: Sep. 15, 2006
(86) PCT No.: PCT/ES2006/070136

§ 371 Date: Apr. 29, 2008

(30) Foreign Application Priority Data
Nov. 4, 2005 (ES) P200502733

(51) Int. Cl. H04M 15/00; H04M 1/64; G06Q 30/00

(52) U.S. Cl. 379/121.01; 379/87; 705/40

(57) ABSTRACT

The invention relates to a payment system for services provided by means of a telephone call, which uses payment means that differ from those associated with the call charge imposed by the telecommunications operator. The invention comprises means for validating the user's payment means and means for fixing rates and charging for the service. The invention is suitable for use in the field of added-value telecommunications services, premium rate services and network intelligence services. The invention is characterised in that the charge is collected from the user's payment means in real time according to the use of the service.

### TECHNICAL FIELD OF THE INVENTION

The invention belongs to the technical field of telecommunications and more specifically to the fields of value added services, premium rate telecommunication services and intelligent networks.

### BACKGROUND

U.S. Pat. No. 4,706,275 shows a telephone system allowing prepayment of telephone calls. An obvious limitation of that solution is that the user must always pay in advance in order to obtain the service.

On the other hand, patent application U.S. 2004128243 shows a generic payment means validation system but without being applicable to pay per use or real time telephone services or to premium rate telephone services (PRS).

There is a need for premium rate telephone services (PRS) that allow pay per use real time billing without being linked to the bills or the payment means of the telecommunications operator that provides the access for the telephone call.

### SUMMARY OF THE INVENTION

With the system and the procedure of the invention the drawbacks previously mentioned are solved with the additional advantages that will be described here.

This invention refers to a payment system for services provided through telephone call that uses payment means distinct to those linked to the billing of the call by the telecommunications operator that provides access for that call comprising means for the validation of the payment means of the user and means for the rating and payment of the service and that it is characterized by the fact that payment is performed through the payment means of the user in real time as a function of the use of the service made by the user.

Payment can be performed for the content of the service provided, prior to the delivery of a part of the service, after the delivery of a part of the service or through a series of time fractions. Besides, the payment means include automated charging of previously unsuccessful charges and service suspension in case of unsuccessful charges. Advantageously, charging can be performed without service interruption and the user can accept or deny a charge interactively previously to the service being performed.

The payment means used by the customer can be credit card, debit card, prepayment card, bank account, Internet payment gateway, mobile phone payment gateway, mobile short message service (SMS). Data input for the payment means can be performed through voice recognition or through the telephone keypad.

Validation of the payment means is performed automatically through an interactive voice response system (IVR).

The service involves a charge for call setup and a charge for an initial billing increment. Both initial charges can be used to validate the user's payment means. That service can be designed as a premium rate service.

The invention can alternatively be described as a payment procedure for services provided through a telephone call that uses means different to those linked to the billing of the call by the telecommunications operator characterized by the following steps: Dialing of the telephone number of the service by the user, input by the user of the data required for the selected payment means and obtaining the payment for the service in real time.

When the service ends a final payment is performed for the unpaid remaining service that the rating means determine. If the user erroneously inputs the required data several consecutive times the call is diverted to an operator or to an interactive voice response service. The data collected for the payment means is stored in an encrypted data base. In addition, the calling number of the user is stored in order to speed up the validation process in subsequent calls. In that case, the user will only be required to input a subset of the required data.

An advantage of the invention is that billing can be performed for content linked to a phone call that is not necessarily included in the cost of the phone call and without having to find the cost of these services in the phone bill of the user's telephone line. This is very useful when the user doesn't want the cost for the service to show in the telephone line's bill which could be owned by another person.

Being this service a real time service where payment is performed without interruption of the service, it is not needed to collect prepayment for an amount bigger than what it is strictly required.

### BRIEF DESCRIPTION OF THE DRAWINGS

For a better understanding of the invention drawings are included that schematically and as an example show an embodiment of the invention. In these drawings:

FIG. 1 is a diagram of the states of the system and procedure for payment of telephone services of the invention.

FIG. 2 is a practical example of the parameters that can be defined in the credit card module of the payment system.

### DETAILED DESCRIPTION

What follows is a detailed description of the preferred embodiment of the invention without being intended to limit the scope of the invention.

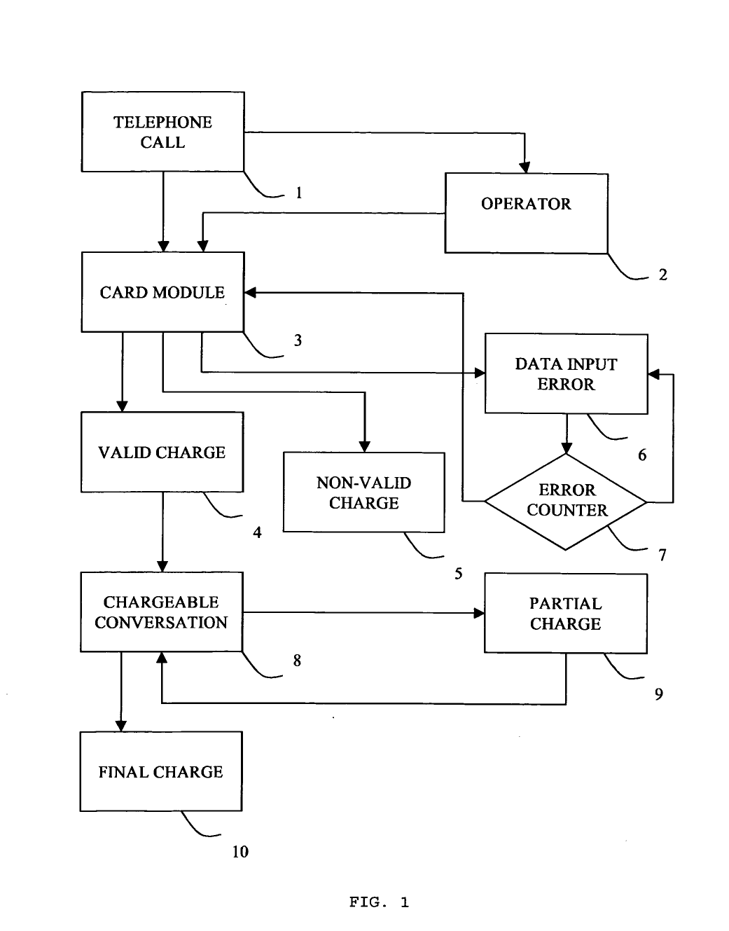

As it is shown in FIG. 1, the user calls the selected service 1. Immediately, the personal data of his credit card (credit card number, expiry date, CES code . . . ) is required and validated in the credit card module 3. In order to check that the credit card data is correct an initial charge is attempted. If the initial charge is correct 8 the user is allowed to start using the requested service. At that point the user is billed in real time 9 while the telephone conversation goes on. When the conversation ends, the remaining time since the last charge is billed 10.

The user has the possibility to contact an operator in case of needing assistance at the time of performing the phone call 2. In the case where the initial charge is invalid 5 the user is informed and the connection is interrupted.

If the user inputs wrong credit card data 6, he is given a certain number of opportunities 7 (for example 2 more opportunities). In case that the data continues to be wrong, it is considered that it is impossible to perform the initial charge and the user is informed before being disconnected.

In the case where the credit card has no more credit, the telephone call would be interrupted after informing the user. An independent automated process would attempt to charge the remaining time offline.

Only in the first call the full credit card data is required. In subsequent calls will suffice with a subset of the data.

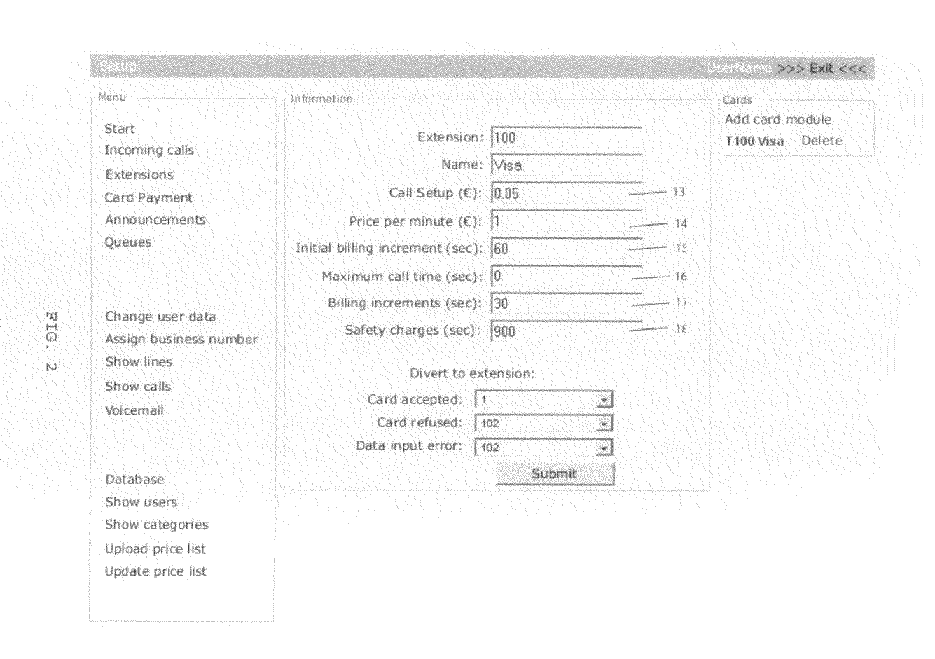

FIG. 2 shows an example of the parameters of rating and charging that can be modified in the credit card module 3. In 13 is established the amount to charge for the call setup (That can be used for the credit card validation). In 14 it is established the amount to charge for every time unit (minutes in that case). In 15 it is established the amount for the initial billing increment, i.e, the minimum conversation fraction of time to charge. In 16 it is established the maximum duration of the conversation (This parameter is useful in order to limit the maximum cost for the user). In 17 it is established the smallest rating unit or billing increment (for example 30 seconds fractions). In 18 it is established the periodicity of charges (For example each 900 seconds). This last parameter is useful to avoid performing too big charges that would increase the risk of a charge being denied by the credit card authority for exceeding the allowed maximum credit amount.

Industry applicability. The invention is to be used in premium rate telecommunication services and paid customer support.

1. Payment system for services performed through a telephone call that uses payment means distinct to those linked to the charging of the call by the telecommunications operator comprising means of validating the payment means of the user; means of rating and charging of the service; characterized by the fact that the charging is performed through the user's payment means in real time by means of successive charges as a function of the usage of the service performed by the user.

2. System according to claim 1 characterized by the fact that charging is performed prior to the delivery of a part of the service.

3. System according to claim 1 characterized by the fact that charging is performed after a part of the service is delivered.

4. System according to claim 3 characterized by the fact that automated charging of previously unsuccessful charges is included.

5. System according to claims 3 characterized by the fact that automated service suspension means are included in case that a charge is unsuccessful.

6. System according to claims 3 characterized by the fact that charging is performed without service interruption.

7. System according to claim 1 characterized by the fact that service rating and charging is performed as a series of time fractions.

8. System according to claim 1 characterized by the fact that charging for the service is performed as a payment for content obtained through the service.

9. System according to claims 1 characterized by the fact that the user can interactively accept or deny a charge prior to the associated service being obtained.

10. System according to claims 1 characterized by the fact that the payment means is a credit card.

11. System according to claims 1 characterized by the fact that the payment means is a debit card.

12. System according to claims 1 characterized by the fact that the payment means is a prepayment card.

13. System according to claims 1 characterized by the fact that the payment means is direct debit to a bank account.

14. System according to claims 1 characterized by the fact that the payment means is an Internet payment gateway.

15. System according to claims 1 characterized by the fact that the payment means is a mobile payment gateway.

16. System according to claims 1 characterized by the fact that the payment means is through SMS.

17. System according to claims 1 characterized by the fact that the payment validation means are automated through an interactive voice response system (IVR)

18. System according to claim 1 characterized by the fact that data input for the payment means is performed via voice recognition.

19. System according to claim 1 characterized by the fact that data input for the payment means is performed through the telephone keypad.

20. System according to claim 1 characterized by the fact that the service includes a call setup charge.

21. System according to claim 1 characterized by the fact that the service implies a charge for an initial time increment.

22. System according to claim 20 characterized by the fact that the call setup charge is used as a mean to validate the user's payment means.

23. System according to claim 21 characterized by the fact that the initial billing increment is used as a mean to validate the user's payment means.

24. System according to claim 1 characterized by the fact that the call setup charge and the initial billing increment are used as a mean to validate the user's payment means.

25. System according to claim 1 characterized by the fact that the service is a premium rate service distinct to the telecommunications carrier service billed by the telecommunications operator.

26. Procedure of payment for services provided through telephone call that uses means of payment distinct to those linked to the charging of the call by the telecommunications operator characterized by the following steps: a) Input by the user of the data required for the selected payment means; b) Validation of the payment means; c) Obtaining the payment for the service in real time by means of successive charges as a function of the usage of the service performed by the user.

27. Procedure according to claim 26 characterized by the fact that this validation consists in performing an initial charge.

28. Procedure according to claim 27 characterized by the fact that this initial charge includes the call setup, the initial billing increment or both concepts.

29. Procedure according to claim 26 characterized by the fact that service rating and charging is performed as a series of time fractions.

30. Procedure according to claim 26 characterized by the fact that charging for the service is performed as a payment for content obtained through the service.

31. Procedure according to claim 26 characterized by the fact that the user can interactively accept or deny a charge prior to the associated service being obtained.

32. Procedure according to claim 26 characterized by the fact that charging is performed prior to the delivery of a part of the service.

33. Procedure according to claim 26 characterized by the fact that charging is performed after a part of the service is delivered.

34. Procedure according to claim 26 characterized by the fact that when the service ends, the remaining time since the last charge determined by the rating system is billed in the form of a final charge.

35. Procedure according to claim 26 characterized by the fact that service is interrupted if one of the charges is unsuccessful.

36. Procedure according to claim 35 characterized by the fact that in the case where a charge cannot be performed, automated means are included in order to attempt the charge offline.

37. Procedure according to claim 26 characterized by the fact that the call is diverted to an operator or to an interactive voice response system (IVR) in case that the user inputs wrong data several consecutive times.

38. Procedure according to claim 26 characterized by the fact that the data required for the selected payment means is stored in a data base.

39. Procedure according to claim 38 characterized by the fact that this data base is encrypted.

40. Procedure according to claim 38 characterized by the fact that in addition the calling number of the user is stored in order to speed up the validation process of the user on subsequent calls.

41. Procedure according to claim 40 characterized by the fact that if the user's data is already stored, only the input of a subset of the data is required.

42. Device for use in a telephone network that includes an interactive voice response system (IVR) and a rating and charging unit where the interactive voice response system performs the validation of the payment means characterized by the fact that the rating and charging unit performs in real time a series of charges corresponding to the duration of the call up to the instant in time when each charge is performed, employing a credit system external to the telephone network.
